(19) United States
(12) Patent Application Publication
(10) Pub. No.: US 2023/0177029 A1
(43) Pub. Date: Jun. 8, 2023

(54) DETECTING AND UPDATING DUPLICATE DATA RECORDS

(71) Applicant: American Express Travel Related Services Company, Inc., New York, NY (US)

(72) Inventors: Vincent Julien David, Port Washington, NY (US); Yogaraj Jayaprakasam, Phoenix, AZ (US); Daniel Reznik, Staten Island, NY (US)

(21) Appl. No.: 18/103,016

(22) Filed: Jan. 30, 2023

Related U.S. Application Data
(63) Continuation of application No. 15/810,917, filed on Nov. 13, 2017.

(51) Int. Cl. G06F 16/215; G06F 16/23; G06F 16/27; G06F 16/174

(52) U.S. Cl. CPC G06F 16/215; G06F 16/27; G06F 16/1748; G06F 16/2365; G06F 16/285

(57) ABSTRACT

Systems, methods, and articles of manufacture for detecting and updating duplicate data records are provided. The system may be configured to detect and retrieve duplicate data records in a data storage and generate a data duplicate reference set comprising the duplicate data records. The duplicate data records may be grouped into common data duplicate groups within the data duplicate reference set. The system may elect one of the duplicate data records from one of the data duplicate groups to be an ACE record. The ACE record may be enriched using the remaining duplicate data records. Data from each duplicate data record may then be overwritten using the ACE record data to ensure that all of the duplicate data records comprise the same data. All of the duplicate data records may be cross-linked in the data storage to ensure consistency and data integrity throughout the data duplicate group.

### FIELD

The disclosure relates to systems for detecting, evaluating, and updating duplicate data records in a data processing environment.

### BACKGROUND

Large data sets may exist in various sizes and organizational structures. With big data comprising data sets as large as ever, the volume of data collected incident to the increased popularity of online and electronic transactions continues to grow. For example, billions of records (also referred to as rows) and hundreds of thousands of columns worth of data may populate a single table. Data processing environments may ingest data from hundreds of data sources with each data source transmitting hundreds of thousands of records. The data sources may be certified data sources having typically high quality data, or uncertified data sources having lower quality data.

When ingesting data, the data processing environment may typically store data records that are determined to be new to the environment (e.g., data records that do not preexist). Incoming data that is determined to be related to stored data records may be used to update and enrich the stored data record. Data may be ingested from uncertified data sources or other data sources providing low quality data (e.g., incorrect data, unformatted data, data with missing fields, or the like). As such, data records having low data quality may be identified and stored as separate records leading to duplicate data records in the data processing environment. Duplicate data records may at least partially limit the ability of the data processing environment to produce accurate data aggregations, and may also at least partially limit the accuracy, consistency, and completeness in updating and enriching the stored data records. Typically, duplicate data records may be identified and removed from the data processing environment. This may lead to problems in downstream consumer systems that previously relied on the removed duplicate data record, as requests for data that previously linked to the removed data record will no longer be valid.

### SUMMARY

Systems, methods, and articles of manufacture (collectively, the “system”) for detecting and updating duplicate data records are disclosed. The system may generate a data duplicate reference set, wherein the data duplicate reference set comprises a data duplicate group, and wherein the data duplicate group comprises a plurality of duplicate data records. The system may elect one of the duplicate data records to be an ACE record. The system may enrich the ACE record to include a portion of data from the remaining duplicate data records. The system may overwrite the data in the remaining duplicate data records to comprise the ACE record data from the ACE record.

In various embodiments, the plurality of duplicate data records may each comprise metadata including a system ID field, a data record, an ACE ID field, an is_active field, an AKA field, and a last update field. The ACE record may be elected based on election logic comprising at least one of determining that the duplicate data record was previously selected as the ACE record, determining the duplicate data record having the most data entries in the AKA field, or determining the duplicate data record having the is_active field set to an active status.

In various embodiments, enriching the ACE record may further comprise adding a system ID of each remaining duplicate data record to an AKA list. The system may further modify the AKA field of each remaining duplicate data record to comprise AKA data from the AKA list. The system may also modify the ACE ID field of each remaining duplicate data record to comprise the system ID of the ACE record. The system may also modify the is_active field of each remaining duplicate data record to comprise status data indicating an inactive status.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for detecting and updating duplicate data records, in accordance with various embodiments;

FIG. 2 is a block diagram illustrating an exemplary data processing environment for a system for detecting and updating duplicate data records, in accordance with various embodiments;

FIG. 3A illustrates an exemplary data input, in accordance with various embodiments;

FIG. 3B illustrates an exemplary storage data model in the exemplary data processing environment of FIG. 2, in accordance with various embodiments;

FIG. 4 illustrates a process flow for a method of detecting and updating duplicate data records, in accordance with various embodiments;

FIG. 5 illustrates a process flow for a method of enriching an ACE data record with duplicate data records, in accordance with various embodiments; and

FIG. 6 illustrates a process flow for a method of updating duplicate data records based on the ACE data record, in accordance with various embodiments.

### DETAILED DESCRIPTION

The detailed description of exemplary embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any logical order and are not limited to the order presented. Moreover, any of the functions or steps may be outsourced to or performed by one or more third parties. Furthermore, any reference to singular includes plural embodiments, and any reference to more than one component may include a singular embodiment.

The present disclosure provides a system, method, and article of manufacture (collectively, “the system”) for detecting and updating duplicate data records in a data processing environment. The system may intelligently detect and update duplicate data records to enrich each duplicate data record. In various embodiments, the system may also at least partially reduce the storage of incorrect or incomplete data by normalizing the data and storing only a single copy of the data. In various embodiments, the system may also maintain internal data references to allow for the continued requests and transmittal of the duplicate data records, independently or in the aggregate. The system may enable all duplicate data records to comprise the same data so that preexisting data requests (e.g., data requests that use at least some preexisting data identifiers) may still receive accurate, consistent, and complete data records. One of the duplicate data records may be marked as “active,” with each corresponding duplicate data record being linked to the active data record, so that future data requests can accurately identify the main data record and/or so that active data records may be queried in the system.

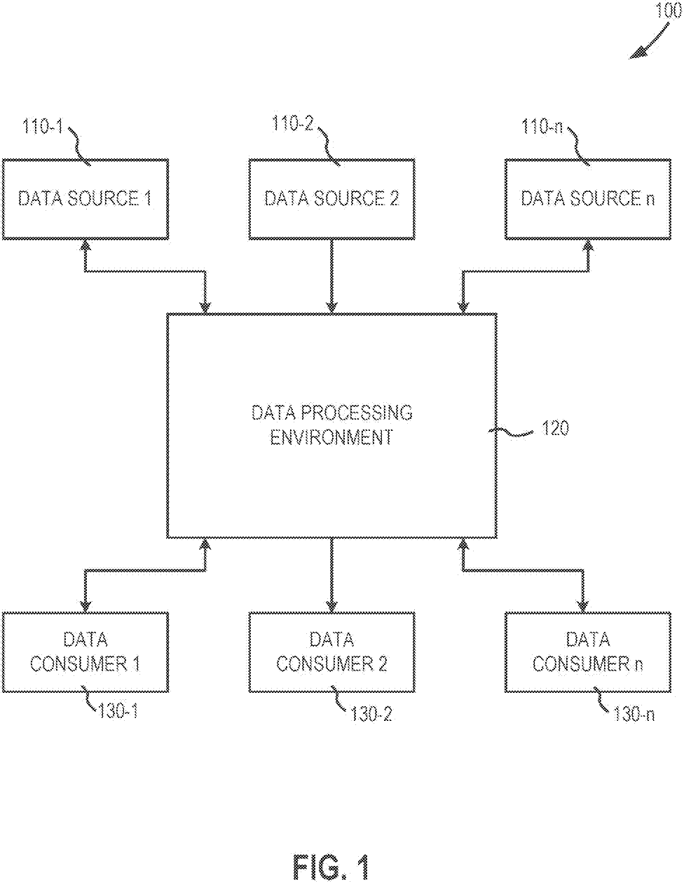

The system further improves the functioning of the computer (e.g., data processing environment 120, with brief reference to FIG. 1). For example, reducing duplicate data records may at least partially increase the ability of the data processing environment to produce more accurate data aggregations, and may also at least partially increase the accuracy, consistency, and completeness in updating and enriching the stored data records. Moreover, by maintaining data records instead of decommissioning duplicate data records, the system reduces the need for repeated data identification requests, which further decreases processing needed by the data processing environment and/or computer-based system. Furthermore, by automating the evaluation, handling, and updating of duplicate data records as opposed to needing the user to manually evaluate, update, and input data, the user performs less computer functions and provides less input, which saves on data storage and memory, thus speeding processing in the computer. Moreover, by at least partially reducing the need for user input, the speed of evaluating, updating, and storing data may be increased. Additionally, by transmitting, storing, and accessing data using the processes described herein, the security of the data is improved, which decreases the risk of the computer or network, or the data itself (including confidential data) from being compromised. In various embodiments wherein duplicate data records are removed from the system, the system may further decrease necessary storage needed to maintain data records.

In various embodiments, and with reference to FIG. 1, a system 100 for detecting and updating duplicate data records is disclosed. System 100 may be computer based, and may comprise a processor, a tangible non-transitory computer-readable memory, and/or a network interface, along with other suitable system software and hardware components. Instructions stored on the tangible non-transitory memory may allow system 100 to perform various functions, as described herein. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing.

In various embodiments, system 100 may comprise one or more data sources 110, a data processing environment 120, and/or one or more data consumers 130. The various systems and components described herein may be in direct logical communication with each other via a bus, network, and/or through any other suitable means, or may be individually connected as described further herein.

In various embodiments, system 100 may comprise any suitable number of data sources 110, such as, for example, a first data source 110-1, a second data source 110-2, and/or an “Nth” data source 110-n. Each data source 110-1, 110-2, 110-n may be in logical and/or electronic communication with data processing environment 120. Each data source 110-1, 110-2, 110-n may be configured to transmit input data (e.g., data records, unformatted data, formatted date, etc.) to data processing environment 120. In various embodiments, data sources 110-1, 110-2, 110-n may comprise any source of data existing in system 100, and/or any other suitable system environment. For example, each data source 110-1, 110-2, 110-n may comprise data related to financial and/or transactional systems and processes, such as, for example, a merchant submission system, a settlement database, an accounts receivable database, and/or the like. Each data source 110-1, 110-2, 110-n may be a certified data source (e.g., a data source of known origin having high quality data) or uncertified data source (e.g., a data source of unknown origin having typically lower quality data) and may provide data inputs having varying qualities (e.g., missing data values, grammatical errors, etc.).

In various embodiments, data sources 110-1, 110-2, 110-n may be part of a big data environment, and each data source 110-1, 110-2, 110-n may transmit hundreds of thousands of records. As used herein, “big data” may refer to partially or fully structured, semi-structured, or unstructured data sets including millions of rows and hundreds of thousands of columns. For example, the transferred records may be based on accounts payable data. The accounts payable data may comprise data regarding commercial entities, merchants, or the like, such as, for example, business names, addresses, phone numbers, email addresses, and transaction identifying data such as transaction accounts, payment amounts, or the like. In various embodiments, the transmitted accounts payable data may comprise varying data qualities (e.g., outdated or missing data fields) and varying data formats.

In various embodiments, data processing environment 120 may be configured to ingest data input from data sources 110-1, 110-2, 110-n; parse, transform, and store the data input (as discussed further herein); and provide the data input to downstream data consumers (e.g., a first data consumer 130-1, a second data consumer 130-2, and/or an “Nth” data consumer 130-n). Data processing environment 120 may be configured to process hundreds of thousands of records from a single data source. Data processing environment 120 may also be configured to ingest data from hundreds of data sources. System 100 may comprise any suitable number of data consumers. Each data consumer 130-1, 130-2, 130-n may comprise any suitable consumer of data existing in system 100, and/or any other suitable system environment. Each data consumer 130-1, 130-2, 130-n may be in electronic and/or operable communication with data processing environment 120.

Data processing environment 120 may comprise any suitable system, module, environment, or the like. For example, data processing environment 120 may comprise a distributed file system. An exemplary distributed file system may comprise a distributed computing cluster configured for parallel processing and storage. Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Serial No. 14/944,902 titled INTEGRATED BIG DATA INTERFACE FOR MULTIPLE STORAGE TYPES and filed on Nov. 18, 2015; U.S. Serial No. 14/944,979 titled SYSTEM AND METHOD FOR READING AND WRITING TO BIG DATA STORAGE FORMATS and filed on Nov. 18, 2015; U.S. Serial No. 14/945,032 titled SYSTEM AND METHOD FOR CREATING, TRACKING, AND MAINTAINING BIG DATA USE CASES and filed on Nov. 18, 2015; U.S. Serial No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Serial No. 14/944,898 titled SYSTEMS AND METHODS FOR TRACKING SENSITIVE DATA IN A BIG DATA ENVIRONMENT and filed on Nov. 18, 2015; and U.S. Serial No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

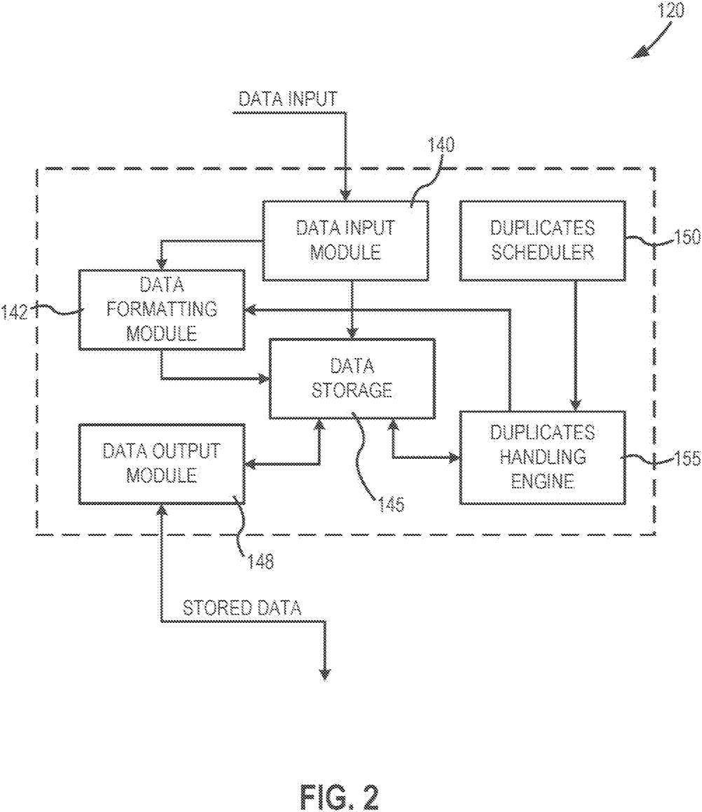

In various embodiments, data processing environment 120 may comprise one or more systems, components, modules, data structures, or the like configured to aide in the ingesting, transformation, parsing, and storing of data inputs. For example, and with reference to FIG. 2, data processing environment 120 may comprise one or more of a data input module 140, a data formatting module 142, a data storage 145, a data output module 148, a duplicates scheduler 150, a duplicates handling engine 155, or the like. The various systems, components, modules, and data structures of data processing environment 120 may comprise logical or virtual partitions of one or more systems, or may each comprise independent processors, components, data structures, or the like. The various systems, components, modules, and data structures of data processing environment 120 may be in direct logical communication with each other via a bus, network, and/or through any other suitable means, or may be individually connected as described further herein.

As used herein, the term “network” may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, ondemand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST’s (National Institute of Standards and Technology) definition of cloud computing.

A network may be unsecured. Thus communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, and symmetric and asymmetric cryptosystems. The systems and methods may also incorporate SHA series cryptographic methods as well as ECC (Elliptic Curve Cryptography) and other Quantum Readable Cryptography Algorithms under development.

In various embodiments, data input module 140 may be in electronic and/or logical communication with data formatting module 142 and/or data storage 145. Data input module 140 may comprise any suitable computer system, processor, or the like capable of receiving data and performing operations. Data input module 140 may include one or more processors and/or one or more tangible, non-transitory memories and be capable of implementing logic. In various embodiments, data input module 140 may comprise a processor configured to implement various logical operations in response to execution of instructions, for example, instructions stored on a non-transitory, tangible, computer-readable medium. Data input module 140 may be configured as a central hub for the transmission of data into data processing environment 120. In that respect, data input module 140 may be configured to ingest data input (e.g., from data sources 110-1, 110-2, 110-n, with brief reference to FIG. 2) and transmit the data input to data formatting module 142.

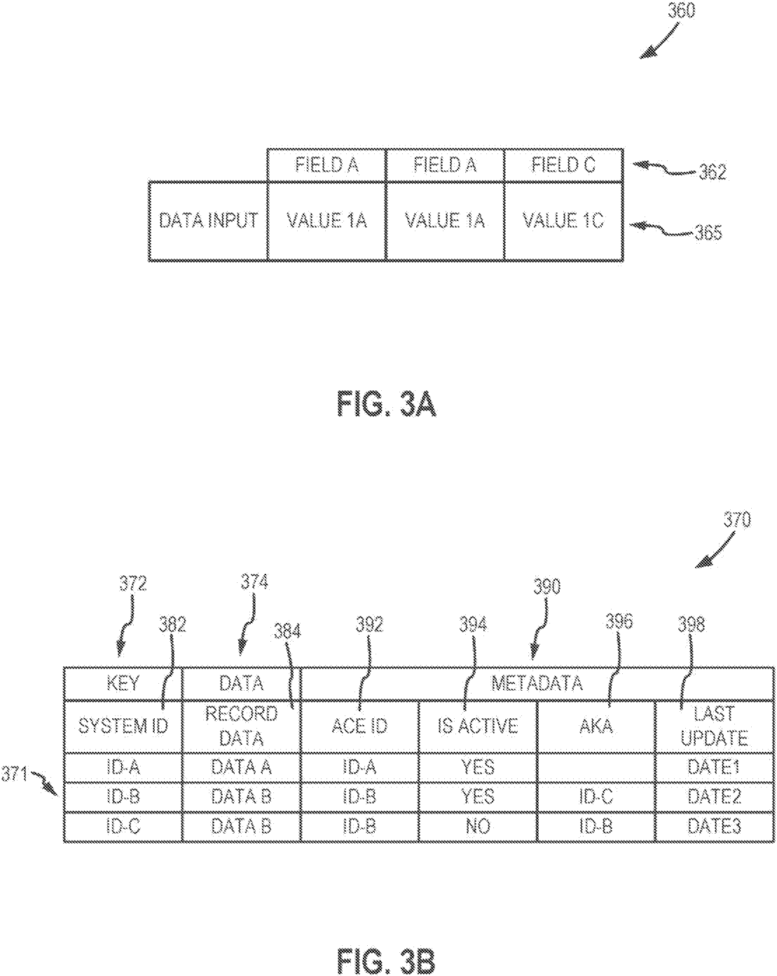

Data input module 140 may also be configured to parse the data input to determine the comprised data values. With brief reference to FIG. 3A, and in accordance with various embodiments, each data input 360 may comprise one or more data values 365 corresponding to one or more data fields 362. For example, data input 360 may comprise a value 1A corresponding to a field A, a value 1B corresponding to a field B, a value 1C corresponding to a field C, and/or the like. In various embodiments, the one or more data fields 362 may be known to data input module 140. For example, each data source 110-1, 110-2, 110-n (with reference to FIG. 2) may format and transmit the data input with metadata, tags, or the like indicating the type of each data field. Data processing environment 120, via data input module 140 (with brief reference to FIG. 2), may receive and recognize each metadata, tag, or the like to determine the type of data fields present in the data input. For example, field A may correspond to a “Business Name”, field B may correspond to a “Last Name”, field C may correspond to an “Address”, etc. In that respect, parsing the data input to determine the data values of known data fields may enable data input module 140 to intelligently determine whether the data input preexists in data processing environment 120, as discussed further herein.

In various embodiments, and with reference again to FIG. 2, in response to parsing the data input and determining one or more data values, data input module 140 may query data storage 145 to determine whether the data is preexisting in data processing environment 120 (e.g., by querying data storage 145 based on one or more data values, identification metadata, or the like). In response to determining that the data input preexists, data input module 140 may determine whether any new data values exist in the data input to enrich the stored data. In response to determining new data values, data input module 140 may update and/or enrich the stored data. In response to determining that the data input does not preexist, data input module 140 may transmit the data input to data formatting module 142.

In various embodiments, data formatting module 142 may be in electronic and/or logical communication with data input module 140, data storage 145, and/or duplicates handling engine 155. Data formatting module 142 may comprise any suitable computer system, processor, or the like capable of receiving data and performing operations. Data formatting module 142 may include one or more processors and/or one or more tangible, non-transitory memories and be capable of implementing logic. In various embodiments, data formatting module 142 may comprise a processor configured to implement various logical operations in response to execution of instructions, for example, instructions stored on a non-transitory, tangible, computer-readable medium. Data formatting module 142 may be configured to receive, transform, and/or format data for storage in data storage 145. In that respect, data formatting module 142 may receive data from data input module 140 and/or duplicates handling engine 155, perform transformations to format the data, and transmit the formatted data to data storage 145. The transformation may comprise a series of logical steps to alter some or all of the data, such as, for example, data formatting steps (such as to stripping white space and truncating numbers to a predetermined length), logical formatting steps, formatting according to the storage data model discussed below, and/or the like as discussed herein or known in the art.

For example, in accordance with various embodiments and with reference to FIG. 3B, a storage data model 370 for data processing environment 120 is depicted. Each data record 371 in storage data model 370 may comprise one or more of a key 372, data 374, and metadata 390. For example, key 372 may comprise a system ID 382. Each data record 371 may be assigned a unique system ID 382 in response to the system determining that the data input is not preexisting in data storage 145 (e.g., ID-A, ID-B, ID-C, and/or any other suitable identifier). Each unique system ID 382 may be stored in a lookup table or the like. As a further example, data 374 may comprise record data 384 that is parsed and identified by data input module 140 in response to receiving the input data (e.g., “DATA A,” “DATA B,” “DATA C,” etc.). In that respect, storage data model 370 may comprise duplicate data, as indicated by the matching DATA B in ID-B and ID-C data records.

As a further example, metadata 390 may comprise an ACE ID field 392, an is_active field 394, an AKA field 396, and a last update field 398. ACE ID field 392 may be used to identify the active data record for duplicate data records, as discussed further herein. In that respect, the ACE ID field 392 may comprise data indicating the system ID 382 of the active data record. For example, data record 371 having system ID “ID-B” comprises an ACE ID of “ID-B” and data record 371 having system ID “ID-C” comprises an ACE ID of “ID-B.” ID-B is the active data record, and therefore, duplicate record ID-C is linked to ID-B via the ACE ID field 392. In response to the data record not having a duplicate record, the ACE ID field 392 may default to that data record’s system ID 382 (e.g., ACE ID of “ID-A” corresponds to same system ID of “ID-A”). The is_active field 394 comprises data indicating whether the data record is active or not. For example, a data record (e.g., “ID-A”) having no duplicate data records is active. A data record that is the active data record in a group of duplicate data records (e.g., “ID-B”) is active, but a data record that is not the active data record in a group of duplicate data records (e.g., “ID-C”) is set to not active. In that regard, the is_active field 394 may be used to at least partially reduce duplicate data records from being matched with new incoming data inputs. The is_active field 394 may be set to “Active,” “Yes,” or a similar positive identifier as default. AKA field 396 may comprise data indicating the system IDs of all known duplicate data records. For example, a data record 371 having no known duplicates would comprise an empty AKA field 396. Data record “ID-B” is a known duplicate of data record “ID-C”, so AKA field 396 for data record “ID-B” comprises data indicating the known duplicate data record of “ID-C.” Likewise, AKA field 396 for data record “ID-C” would also comprise data indicating the known duplicate data record of “ID-B.” AKA field 396 may be empty as default. Last update field 398 may comprise data indicating the last time the data record 371 was updated or changed (e.g., a timestamp). For example, last update field 398 may comprise data indicating a time, a day, a year, or the like wherein the data record 371 was last updated, or in response to the data record being new to the system, the time, the day, the year, or the like wherein the data record 371 was received into data processing environment 120. In various embodiments, changes to metadata 390 in each data record 371 may affect an update to last update field 398. In various embodiments, changed to metadata 390 in each data record 371 may not affect an update to last update field 398.

In various embodiments, and with reference again to FIG. 2, data storage 145 may be in electronic and/or logical communication with data input module 140, data formatting module 142, data output module 148, and/or duplicates handling engine 155. Data storage 145 may comprise any suitable database, data structure (e.g., virtual or physical), flat file structure, or the like, as discussed herein or known in the art. Data storage 145 may be configured to receive data from data formatting module 142 and/or duplicates handling engine 155 and store and maintain the data. Data storage 145 may store and maintain the data using any suitable technique discussed herein or known in the art. For example, the data may be stored according to the data model described in FIG. 3B, as discussed further herein. Data storage 145 may be organized in any suitable manner, for example, as data tables or lookup tables. Each record may be a single file, a series of files, a linked series of data fields or any other data structure.

In various embodiments, duplicates scheduler 150 may be in electronic and/or logical communication with duplicates handling engine 155. Duplicates scheduler 150 may comprise any suitable computer system, processor, or the like capable of receiving data and performing operations. Duplicates scheduler 150 may include one or more processors and/or one or more tangible, non-transitory memories and be capable of implementing logic. In various embodiments, duplicates scheduler 150 may comprise a processor configured to implement various logical operations in response to execution of instructions, for example, instructions stored on a non-transitory, tangible, computer-readable medium. Duplicates scheduler 150 may be configured to invoke duplicates handling engine 155. In that respect, duplicates scheduler 150 may be configured to instruct duplicates handling engine 155 to detect and update duplicate data records in data storage 145, as discussed further herein.

In various embodiments, duplicates handling engine 155 may be in electronic and/or logical communication with duplicates scheduler 150, data formatting module 142, and/or data storage 145. Duplicates handling engine 155 may comprise any suitable computer system, processor, or the like capable of receiving data and performing operations. Duplicates handling engine 155 may include one or more processors and/or one or more tangible, non-transitory memories and be capable of implementing logic. In various embodiments, duplicates handling engine 155 may comprise a processor configured to implement various logical operations in response to execution of instructions, for example, instructions stored on a non-transitory, tangible, computer-readable medium. Duplicates handling engine 155 may be configured to query data storage 145 to determine and retrieve duplicate data records and generate a data duplicate reference set having one or more data duplicate groups, as discussed further herein. Duplicates handling engine 155 may also be configured to evaluate the data duplicate groups, select an ACE record for each data duplicate group, and update the duplicate data records to ensure accuracy, robustness, and continued service to downstream data consumers, as discussed further herein. In response to updating the duplicate data records, duplicates handling engine 155 may also be configured to update data storage 145 and commit the data changes.

In various embodiments, data output module 148 may be in electronic and/or logical communication with data storage 145. Data output module 148 may comprise any suitable computer system, processor, or the like capable of receiving data and performing operations. Data output module 148 may include one or more processors and/or one or more tangible, non-transitory memories and be capable of implementing logic. In various embodiments, data output module 148 may comprise a processor configured to implement various logical operations in response to execution of instructions, for example, instructions stored on a non-transitory, tangible, computer-readable medium. Data output module 148 may be configured to retrieve stored data from data storage 145 and transmit the stored data to one or more data consumers (e.g., data consumers 130-1, 130-2, 130-n, with brief reference to FIG. 1). Data output module 148 may be configured to transmit the stored data in response to a data request, system event, or the like. For example, and in accordance with various embodiments, the data consumers may request data based on the identity of the stored data, such as via a system ID or other identifier. Data output module 148 may handle the requests in batches, in real time, in near-real time, or via any other processing timeline.

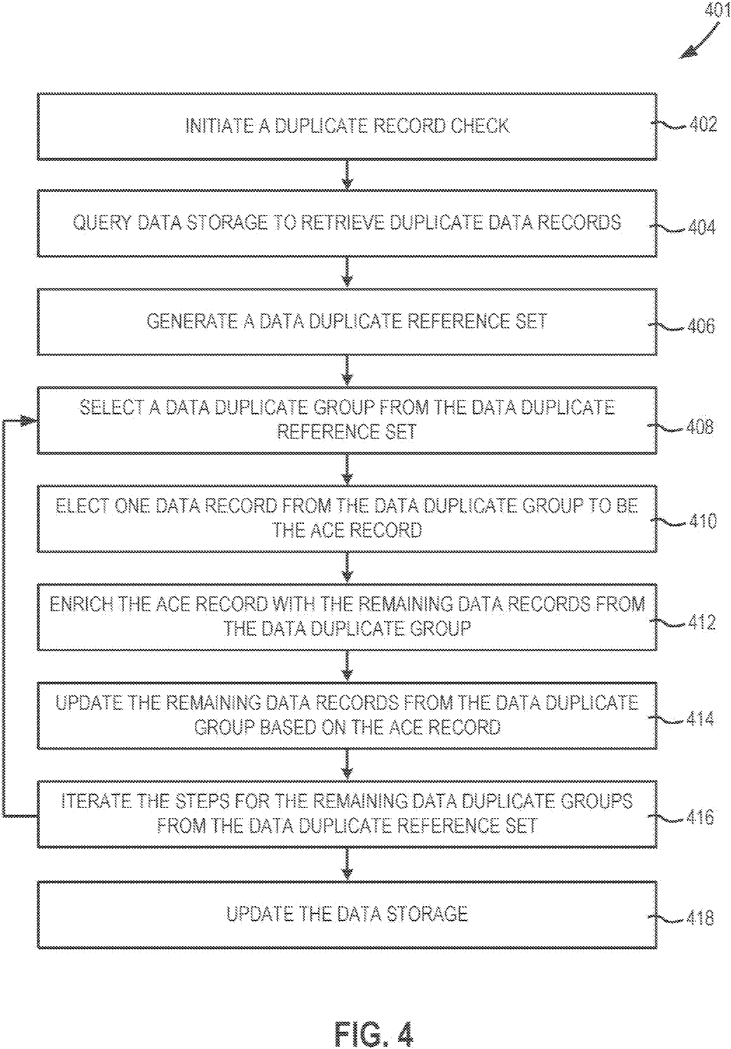

Referring now to FIGS. 4-6, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and elements depicted in FIGS. 4-6, but also to the various system components as described above with reference to FIGS. 1 and 2.

In various embodiments, and with specific reference to FIG. 4, a method 401 for secured account provisioning is disclosed. Method 401 may comprise initiating a duplicate record check (step 402). Duplicates scheduler 150 may be configured to initiate the duplicate record check. In that regard, duplicates scheduler 150 may invoke duplicates handling engine 155 to initiate the duplicate record check. Duplicates scheduler 150 may be configured to initiate the duplicate record check based on a user input, a duplicates schedule (e.g., data instructing duplicates scheduler 150 to initiate the duplicate record check every day, week, month, etc.), or the like.

In various embodiments, method 401 may comprise querying data storage 145 to retrieve duplicate data records (step 404). Duplicates handling engine 155 may be configured to query data storage 145 in response to being invoked by duplicates scheduler 150. Duplicates handling engine 155 may determine the time of the previous duplicate record check (e.g., via reference data in duplicates handling engine 155, or reference data in data storage 145). Duplicates handling engine 155 may query data storage 145 to determine all data records that are new to data storage 145 or have been updated (e.g., as determined by last update field 398) since the previous duplicate record check. Based on that determination, duplicates handling engine 155 may query data storage 145 based on each of the identified records to determine and retrieve duplicate data records in data storage 145. Duplicates handling engine 155 may identify duplicate data records based on any suitable technique, such as, for example my matching incremental data against a high-quality dataset, by invoking an external data matching capabilities (e.g., commercial products offered by GOOGLE®, Dun and Bradstreet®, etc.), and/or via any other suitable data analytics platform. In that respect, duplicate data records that have been received or identified since the previous duplicate record check may be retrieved. In various embodiments, duplicate data records may be identified only against active data records (e.g., data records having an is_active data field set to “active”), as discussed further herein.

In various embodiments, method 401 may comprise generating a data duplicate reference set (step 406). Duplicates handling engine 155 may be configured to generate the data duplicate reference set. The data duplicate reference set may comprise all of the duplicate data records retrieved in step 404. Duplicates handling engine 155 may generate the data duplicate reference set to comprise one or more data duplicate groups. Each data duplicate group may comprise one or more related data duplicate records. In that respect, duplicates handling engine 155 may group the data duplicate records to form each data duplicate group. In various embodiments, each data duplicate group may comprise the system IDs of each data duplicate record, or may comprise the full data and metadata of each data duplicate record. Method 401 may comprise selecting a data duplicate group from the data duplicate reference set (step 408). Duplicates handling engine 155 may select one of the data duplicate groups for processing randomly or based on any suitable logic.

In various embodiments, method 401 may comprise electing a data record from the data duplicate group to be the ACE record (step 410). Duplicates handling engine 155 may be configured to elect the data record from the data duplicate group based on any suitable method, such as, for example, through election logic. For example, in response to determining that a data record from the data duplicate group was previously elected as an ACE record (e.g., via metadata, or the like), duplicates handling engine 155 may elect that record as the ACE record. In response to determining that more than one data record from the data duplicate group was previously elected as an ACE record, duplicates handling engine 155 may elect the data record having the longest AKA list (e.g., as determined via the AKA field). Duplicates handling engine 155 may also only consider data records having metadata indicating that the record is active (e.g., via the is_active field). Duplicates handling engine 155 may also employ any other suitable election logic in electing the data record to be the ACE record. For example, duplicates handling engine 155 may introduce a sticky ACE to data records. The sticky ACE may allow for duplicates handling engine 155 to flag a data record. The data record comprising the sticky ace will override typically ACE record election such that the data record with the sticky ace always stays as an ACE ID.

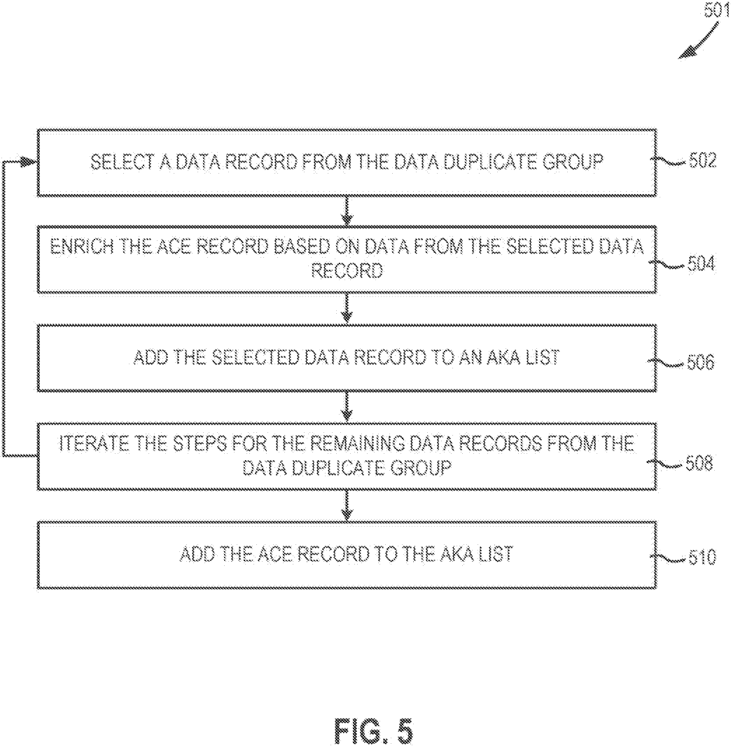

Method 401 may comprise enriching the ACE record with the remaining data records from the data duplicate group (step 412). In response to electing a data record to be the ACE record, duplicates handling engine 155 may be configured to enrich the ACE record with data from the remaining data records in the data duplicate group. Duplicates handling engine 155 may enrich the ACE record using any suitable method. For example, in accordance with various embodiments and with reference to FIG. 5, a process flow for a method 501 of enriching an ACE data record with duplicate data records is disclosed. Method 501 may comprise selecting a data record from the data duplicate group (step 502). Duplicates handling engine 155 may be configured to select the data record (excluding the data record that was previously elected to be the ACE record).

In various embodiments, method 501 may comprise enriching the ACE record based on data from the selected data record (step 504). Duplicates handling engine 155 may be configured to enrich the ACE record. In that regard, duplicates handling engine 155 may parse the selected data record to determine the data contained therein. Duplicates handling engine 155 may compare the parsed data to the data in the ACE record. In response to determining that the parsed data at least partially contains data that is not present in the ACE record, duplicates handling engine 155 may update and enrich the ACE record to comprise a portion of data from the selected data record. Method 501 may comprise adding the selected data record to an AKA list (step 506). Duplicates handling engine 155 may generate the AKA list and may add the system ID of the selected data record to the AKA list. Method 501 may comprise iterating the steps for the remaining data records from the data duplicate group (step 508). Steps 502, 504, 506, and 508 may be repeated until all of the data records in the duplicate data group are processed. In that regard, the AKA list may then comprise the system IDs of all of the data records that were used to enrich the ACE record (e.g., as AKA data). Method 501 may comprise adding the ACE record to the AKA list (step 510). In that regard, the AKA list may then comprise the system IDs of all of the duplicate data records from the data duplicate group (e.g., as AKA data).

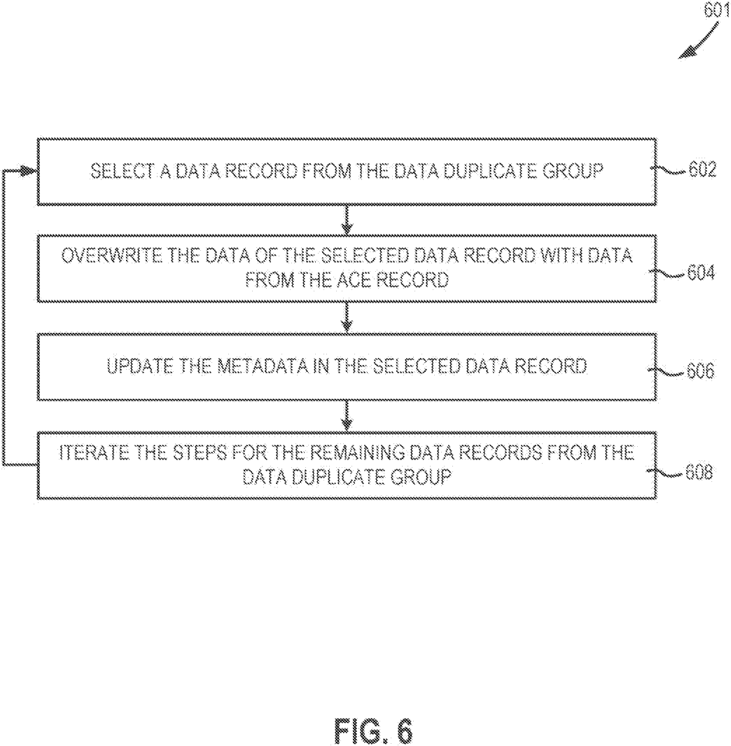

In various embodiments, and with reference again to FIG. 4, method 401 may comprise updating the remaining data records from the data duplicate group based on the ACE record (step 414). Duplicates handling engine 155 may be configured to update the data records using any suitable technique. For example, in accordance with various embodiments and with reference to FIG. 6, a method 601 for updating duplicate data records based on the ACE data record is disclosed. Method 601 may comprise selecting a data record from the data duplicate group (step 602). Duplicates handling engine 155 may be configured to select the data record (excluding the data record that was previously elected to be the ACE record). Method 601 may comprise overwriting the data of the selected data record with data from the ACE record (step 604). Duplicates handling engine 155 may parse the ACE record to determine the data contained therein (e.g., the ACE record data). Duplicates handling engine 155 may overwrite the data in the selected data record with the parsed data (e.g., the ACE record data) from the ACE record.

In various embodiments, method 601 may comprise updating the metadata in the selected data record (step 606). Duplicates handling engine 155 may be configured to update the metadata. For example, and with additional reference to FIG. 3B, duplicates handling engine 155 may be configured to update metadata 390. For example, the ACE ID field 392 may be updated to reflect the system ID 382 of the previous elected ACE record. Status data in the is_active field 394 may be updated to “No” (or to any other suitable such status indicator, such as “active”, “inactive”, or the like). In various embodiments, data records having an is_active field 394 set to “No” may be excluded by the system when determining whether data inputs are new or existing in the system. The AKA field 396 may be updated based on the generated AKA list. In that respect, the AKA field 396 may comprise the system IDs 382 of all related duplicate data records. The AKA field 396 may be updated to exclude the system ID of the currently selected data record being updated. The last update field 398 may be updated to reflect the current time, day, year, etc. as of the time of updating the metadata.

Method 601 may comprise iterating the steps for the remaining data records from the data duplicate group (step 608). Steps 602, 604, 606, and 608 may be repeated until all of the data records in the duplicate data group are processed. In that regard, all of the data records from the data duplicate group will then comprise the same enriched data. In various embodiments, and with reference again to FIG. 4, method 401 may comprise iterating the steps for the remaining data duplicate groups from the data duplicate reference set (step 416). Steps 408, 410, 412, 414, and 416 may be repeated until all of the data duplicate groups from the data duplicate reference set have been processed, and all data duplicates have been handled and updated. Method 401 may comprise updating data storage 145 (step 418). Duplicates handling engine 155 may transmit the data duplicate reference set to data storage 145, and commit the updates.

The disclosure and claims do not describe only a particular outcome of detecting and updating duplicate data records, but the disclosure and claims include specific rules for implementing the outcome of detecting and updating duplicate data records and that render information into a specific format that is then used and applied to create the desired results of detecting and updating duplicate data records, as set forth in McRO, Inc. v. Bandai Namco Games America Inc. (Fed. Cir. case number 15-1080, Sept. 13, 2016). In other words, the outcome of detecting and updating duplicate data records can be performed by many different types of rules and combinations of rules, and this disclosure includes various embodiments with specific rules. While the absence of complete preemption may not guarantee that a claim is eligible, the disclosure does not sufficiently preempt the field of detecting and updating duplicate data records at all. The disclosure acts to narrow, confine, and otherwise tie down the disclosure so as not to cover the general abstract idea of just detecting and updating duplicate data records. Significantly, other systems and methods exist for detecting and updating duplicate data records, so it would be inappropriate to assert that the claimed invention preempts the field or monopolizes the basic tools of detecting and updating duplicate data records. In other words, the disclosure will not prevent others from detecting and updating duplicate data records, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the systems and methods may include alerting a subscriber when their computer is offline. With brief reference to FIG. 1, system 100 may include generating customized information, via data processing environment 120, and alerting a remote subscriber that the information can be accessed from their computer (e.g., via data consumers 130). The alerts are generated by filtering received information, building information alerts and formatting the alerts into data blocks based upon subscriber preference information. The data blocks are transmitted to the subscriber’s wireless device (e.g., data consumers 130), which, when connected to the computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber’s preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer comes online.

In various embodiments, the system and method may include a graphical user interface (e.g., via data consumers 130) for dynamically relocating/rescaling obscured textual information of an underlying window to become automatically viewable to the user. By permitting textual information to be dynamically relocated based on an overlap condition, the computer’s ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user’s view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

As used herein, “transmit” may include sending electronic data from one system component to another over a network connection. Additionally, as used herein, “data” may include encompassing information such as commands, queries, files, data for storage, and the like in digital or any other form.

Phrases and terms similar to “transaction account” may include any account that may be used to facilitate a financial transaction. For example, a transaction account as used herein may refer to an account associated with an open account or a closed account system (as described herein). The transaction account may exist in a physical or nonphysical embodiment. For example, a transaction account may be distributed in nonphysical embodiments such as an account number, frequent-flyer account, telephone calling account, and/or the like. Furthermore, a physical embodiment of a transaction account may be distributed as a financial instrument, such as, for example, a credit card, debit card, and/or the like.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

The system or any components may integrate with system integration technology such as, for example, the ALEXA® system developed by AMAZON®. ALEXA® is a cloud-based voice service that can help with tasks, entertainment, general information and more. All AMAZON® ALEXA® devices, such as the AMAZON® Echo, AMAZON® Dot, AMAZON® Tap, AMAZON® Fire TV, have access to the ALEXA® Voice Service. The system may receive voice commands via its voice activation technology, and activate other functions, control smart devices and/or gather information. For example, music, emails, texts, calling, questions answered, home improvement information, smart home communication/activation, games, shopping, making to-do lists, setting alarms, streaming podcasts, playing audiobooks, and providing weather, traffic, and other real time information, such as news. The system may allow the user to access information about eligible accounts linked to an online account across all ALEXA®-enabled devices.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, Facebook® message, Twitter® tweet and/or message, MMS, and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

A “consumer profile” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the herein particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system may also include a main memory, such as for example random access memory (RAM), and may also include a secondary memory. The secondary memory may include, for example, a hard disk drive and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS, EDB® Postgres Plus Advanced Server® (PPAS), etc.). In various embodiments, the server may include web servers (e.g. APACHE, IIS, GWS, SUN JAVA® SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (“POS”) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

As those skilled in the art will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, OS2, UNIX® OS, LINUX® OS, SOLARIS®, MacOS, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (“TLS”). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and communicates a detected input from the hardware to the micro-app.

Any databases discussed herein may include relational, hierarchical, graphical, blockchain, or object-oriented structure and/or any other database configurations. The databases may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, NY), various database products available from ORACLE® Corporation (Redwood Shores, CA), MICROSOFT® Access® or MICROSOFT® SQL Server® by MICROSOFT® Corporation (Redmond, Washington), MySQL by MySQL AB (Uppsala, Sweden), MongoDB®, Redis®, APACHE® Cassandra®, HBase by APACHE®, MapR-DB by MAPR®, or any other suitable database product. Moreover, the databases may be organized in any suitable manner, for example, as data tables or lookup tables. Each record may be a single file, a series of files, a linked series of data fields or any other data structure.

The blockchain structure may include a distributed database that maintains a growing list of data records. The blockchain may provide enhanced security because each block may hold individual transactions and the results of any blockchain executables. Each block may contain a timestamp and a link to a previous block. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. For more information on blockchain-based payment networks, see U.S. Application No. 15/266,350 titled SYSTEMS AND METHODS FOR BLOCKCHAIN BASED PAYMENT NETWORKS and filed on Sep. 15, 2016, U.S. Application No. 15/682,180 titled SYSTEMS AND METHODS FOR DATA FILE TRANSFER BALANCING AND CONTROL ON BLOCKCHAIN and filed Aug. 21, 2017, U.S. Application No. 15/728,086 titled SYSTEMS AND METHODS FOR LOYALTY POINT DISTRIBUTION and filed Oct. 9, 2017, U.S. Application No. 15/785,843 titled MESSAGING BALANCING AND CONTROL ON BLOCKCHAIN and filed on Oct. 17, 2017, and U.S. Application No. 15/785,870 titled API REQUEST AND RESPONSE BALANCING AND CONTROL ON BLOCKCHAIN and filed on Oct. 17, 2017, the contents of which are each incorporated by reference in its entirety.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may then be designated as a key field in a plurality of related data tables and the data tables may be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using fixed storage allocation, circular queue techniques, or best practices with respect to memory management (e.g., paged memory, least recently used, etc.). By using BLOB methods, the ability to store various data sets that have different formats facilitates the storage of data, in the database or associated with system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device, or transaction instrument in relation to the appropriate data.

In various embodiments, a big data set may be compiled, for example, from a history of purchase transactions over time, from web registrations, from social media, from records of charge (“ROC”), from summaries of charges (“SOC”), from internal data, and/or from other suitable sources. Big data sets may be compiled without descriptive metadata such as column types, counts, percentiles, or other interpretive-aid data points. As discussed further herein, the big data sets may be stored in various big-data storage formats containing millions of records (i.e., rows) and numerous variables (i.e., columns) for each record. A record of charge (or “ROC”) may comprise any transaction or transaction data. The ROC may be a unique identifier associated with a transaction. Record of Charge (ROC) data includes important information and enriched data. For example, a ROC may contain details such as location, merchant name or identifier, transaction amount, transaction date, account number, account security pin or code, account expiry date, and the like for the transaction. Such enriched data increases the accuracy of matching the transaction data to the receipt data. Such enriched ROC data is not equivalent to transaction entries from a banking statement or transaction account statement, which may typically be limited to basic data about a transaction. Furthermore, a ROC is provided by a different source, namely the ROC is provided by the merchant to the transaction processor. In that regard, the ROC is a unique identifier associated with a particular transaction. A ROC is often associated with a Summary of Charges (SOC). The ROCs and SOCs include information provided by the merchant to the transaction processor, and the ROCs and SOCs are used in the settlement process with the merchant. A transaction may, in various embodiments, be performed by one or more members using a transaction account, such as a transaction account associated with a gift card, a debit card, a credit card, and the like.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, and symmetric and asymmetric cryptosystems. The systems and methods may also incorporate SHA series cryptographic methods as well as ECC (Elliptic Curve Cryptography) and other Quantum Readable Cryptography Algorithms under development.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (“MTS”), and MICROSOFT® SQL Server, are used in conjunction with the MICROSOFT® operating system, MICROSOFT® web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (“ADO”) compliant database management system. In one embodiment, the Apache web server is used in conjunction with a Linux operating system, a MySQL database, and the Perl, PHP, Ruby, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (“ASP”), common gateway interface scripts (“CGI”), extensible markup language (“XML”), dynamic HTML, cascading style sheets (“CSS”), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQTM (formerly MQSeries) by IBM®, Inc. (Armonk, NY) is an example of a commercially available middleware product. An Enterprise Service Bus (“ESB”) application is another example of middleware.

Those skilled in the art will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as APACHE® Pig, C, C++, C#, APACHE® Hive, JAVA®, JAVASCRIPT, JAVASCRIPT Object Notation (“JSON”), VBScript, Macromedia Cold Fusion, COBOL, MICROSOFT® Active Server Pages, assembly, PERL, PHP, awk, Python, Ruby, Visual Basic, SQL Stored Procedures, Spark, Scala, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. Cryptography and network security methods are well known in the art, and are covered in many standard texts.

In various embodiments, the software elements of the system may also be implemented using Node.Node.js®. Node.js® may implement several modules to handle various core functionalities. For example, a package management module, such as npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is intended to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1-20. (canceled)

21. A system, comprising:
at least one computing device comprising a processor and a memory; and
machine-readable instructions stored in the memory that, when executed by the processor, cause the at least computing device to at least:
select a plurality of duplicate data records from a duplicate data reference set;
elect one of the plurality of duplicate data records to be an active record;
enrich the active record based at least in part on data from a plurality of
remaining duplicate data records of the plurality of duplicate data records; and
update individual records of the plurality of remaining duplicate data records based at least in part on the active record.

22. The system of claim 21, wherein the machine-readable instructions, when executed by the processor, further cause the at least one computing device to at least:
initiate a duplicate data record check;
retrieve a plurality of duplicate data records from a data store; and
generate the data duplicate reference set based at least in part on the plurality of duplicate data records.

23. The system of claim 21, wherein the one of the plurality of duplicate data records is elected as the active record based at least in part on a number of entries in a duplicate list field of the one of the duplicate data records.

24. The system of claim 21, wherein the machine-readable instructions that cause the at least one computing device to enrich the active record based at least in part on the data from the plurality of remaining duplicate data records further cause the at least one computing device to at least:
compare data from at least one of the remaining duplicate data records with data from the active record;
modify the data from the active data record to comprise at least a portion of the data from the at least one remaining duplicate data records; and
modify a duplicate list field of the active record to comprise an identifier for the at least one of the remaining duplicate data records.

25. The system of claim 21, wherein the machine-readable instructions that cause the at least one computing device to at least update the individual records of the plurality of remaining duplicate data records based at least in part on the active record further cause the at least one computing device to at least overwrite data of individual records of the remaining duplicate data records with data from the active record.

26. The system of claim 21, wherein the machine-readable instructions that cause the at least one computing device to at least update the individual records of the plurality of remaining duplicate data records based at least in part on the active record further cause the at least one computing device to at least modify a duplicate list field of individual records of the plurality of remaining duplicate data records to comprise a duplicate list from a duplicate list field of the active record, the duplicate list field comprising respective identifiers for individual records of the plurality of duplicate data records.

27. The system of claim 21, wherein the individual records of the plurality of duplicate data records further comprise a system identifier field, an active record identifier field, a duplicate list field, and a last update field.

28. A method, comprising:
electing, by at least one computing device, one of a plurality of duplicate data records to be an active record;
modifying, by the at least one computing device, data from the active record based at least in part on data from a plurality of remaining duplicate data records;
modifying, by the at least one computing device, data from individual records of the plurality of remaining duplicate data records based at least in part on the data from the active record; and
modifying, by the at least one computing device, metadata from the individual records of the plurality of remaining duplicate data records based at least in part the active record.

29. The method of claim 28, further comprising:
initiating a duplicate data record check in response to user input; and
retrieving the plurality of duplicate data records from a data store.

30. The method of claim 28, wherein the one of the plurality of duplicate data records is elected as the active record based at least in part on determining that the one of the plurality of the duplicate data records was previously elected as an active record.

31. The method of claim 28, wherein modifying data from the active record based at least in part on the data from the plurality of remaining duplicate data records further comprises:
comparing, by the at least one computing device, the data from at least one of the remaining duplicate data records with data from the active record;
modifying, by the at least one computing device, the data from the active data record to comprise at least a portion of the data from the at least one remaining duplicate data records; and
modifying, by the at least one computing device, a duplicate list field of the active record to comprise an identifier for the at least one of the remaining duplicate data records.

32. The method of claim 28, wherein modifying data from the individual records of the plurality of remaining duplicate data records based at least in part on the data from the active record further comprises overwriting data of individual records of the remaining duplicate data records with data from the active record.

33. The method of claim 28, wherein modifying metadata from the individual records of the plurality of remaining duplicate data records based at least in part the active record further comprises modifying a duplicate list field of individual records of the plurality of remaining duplicate data records to comprise a duplicate list from a duplicate list field of the active record, the duplicate list field comprising respective identifiers for individual records of the plurality of duplicate data records.

34. The method of claim 28, wherein individual records of the plurality of duplicate data records further comprise a system identifier field, an active record identifier field, a duplicate list field, and a last update field.

35. A non-transitory, computer readable medium embodying program instructions that, when executed, cause at least one computing device to at least:
retrieve a plurality of groups of duplicate data records from a data store;
select a group of duplicate data records from the plurality of groups of duplicate data records;
identify an active record from the group of duplicate data records;
enrich the active record based at least in part on at least one remaining duplicate data record from the group of duplicate data records; and
update the at least one remaining duplicate data records based at least in part on the active record.

36. The non-transitory, computer-readable medium of claim 35, wherein the active record is elected identified based at least in part on at least one of a number of entries in a duplicate list field of the one of the duplicate data records or the active record having been previously identified as an active record.

37. The non-transitory, computer-readable medium of claim 35, wherein the program instructions that cause the at least one computing device to at least enrich the active record based at least in part on the at least one remaining duplicate data record from the group of duplicate data records further cause the at least one computing device to at least:
compare data from the at least one remaining duplicate data record with data from the active record;
modify the data from the active data record to comprise at least a portion of the data from the at least one remaining duplicate data record; and
modify a duplicate list field of the active record to comprise an identifier for the at least one remaining duplicate data record.

38. The non-transitory, computer-readable medium of claim 35, wherein the program instructions that cause the at least one computing device to at least update the at least one remaining duplicate data records based at least in part on the active record further cause the at least one computing device to at least overwrite data of individual records of the remaining duplicate data records with data from the active record.

39. The non-transitory, computer-readable medium of claim 35, wherein the program instructions that cause the at least one computing device to at least update the at least one remaining duplicate data records based at least in part on the active record further cause the at least one computing device to at least modify a duplicate list field of the at least one remaining duplicate data record to comprise a duplicate list from a duplicate list field of the active record, the duplicate list field comprising respective identifiers for individual records of the group of duplicate data records.

40. The non-transitory, computer-readable medium of claim 35, wherein individual records of the group of duplicate data records further comprise a system identifier field, an active record identifier field, a duplicate list field, and a last update field.
